(19) United States
(12) Patent Application Publication
(10) Pub. No.: US 2015/0006256 A1
(43) Pub. Date: Jan. 1, 2015

(54) METHOD FOR FUSING MARKETING DATA AND CELLULAR DATA FOR TRANSPORTATION PLANNING AND ENGINEERING

(71) Applicant: Josephine Denise Kressner, Atlanta, GA (US)

(72) Inventor: Josephine Denise Kressner, Atlanta, GA (US)

(21) Appl. No.: 14/318,329

(22) Filed: Jun. 27, 2014

Related U.S. Application Data
(60) Provisional application No. 61/841,033, filed on Jun. 28, 2013.

(51) Int. Cl. G06Q 50/30; G06Q 30/02

(52) U.S. Cl. CPC G06Q 50/30; G06Q 30/0205
USPC 705/7.34

(57) ABSTRACT

The present invention includes a method for fusing marketing data with cellular or other mobile-device data to create synthetic or fabricated travel data. In some embodiments, the technique comprises obtaining and/or generating marketing data for one or more study areas disaggregated at the individual and/or household levels, obtaining cellular data for the study area(s) aggregated into probabilistic distributions for geographic subareas within the study area(s), and associating travel and activity information from the cellular data with individuals or households in the marketing data by their current residential or commercial subarea using the respective probabilistic distributions in the cellular data.

### CROSS-REFERENCE TO RELATED APPLICATIONS

This application claims the benefit of U.S. Provisional Application No. 61/841,033 filed 28 Jun. 2013, the entire contents and substance of which is hereby incorporated by reference.

### BACKGROUND OF THE INVENTION

1. Field of the Invention

The present invention relates generally to data used in the fields of urban planning and transportation engineering. More particularly, the present invention relates to a method for fusing marketing data with cellular, and other mobile-device data to create synthetic or fabricated travel data.

2. Description of Related Art

Researchers in the fields of urban planning and transportation engineering have traditionally collected data for two purposes: to understand the current state of a region, and to provide inputs into travel forecasting models, e.g., travel demand models (TDMs), which are technical tools that facilitate development and testing of regional transportation plans and assist in the policy decision making process. Traditional TDMs include four-step and activity-based models. Public and private groups spend billions of dollars each year on studies and research related to the collection and utilization of this data.

In pursuing these two purposes, data that is accurate, precise, and timely are required. Mechanisms to obtain this data have historically included household travel surveys, roadside questionnaires/interviews, count stations, speed sensors, video cameras, and other approaches that provide information about the movement of people and goods. However, given the prohibitively high costs of these collection methods and increasingly limited government funding, these traditional collection methods are often unable to provide the accurate, precise, and timely data that are required. Indeed, concern regarding diminishing data in the urban planning and transportation engineering communities has been prevalent for several years.

Household travel surveys have become the fundamental method of data collection in the field and accordingly the main input into TDMs. They are primarily administered by metropolitan planning organizations (MPOs) but can also be administered by local, regional, state, and federal governments or other interested parties and organizations. Their main advantage over other data sources is the direct connection they provide between an individual or household's demographic and socioeconomic characteristics and travel or activity behavior. However, due to the enormously high cost of administering household travel surveys, MPOs and other groups have been forced to collect data infrequently, usually less than once per decade, and for very small samples, typically less than 1% of the population.

U.S. Pat. No. 8,406,770, issued 26 Mar. 2013, identified that there is a need for a cost effective method of collecting and analyzing traffic data. That patent is directed to a system and method for collecting and processing information from users of wireless telephony systems as traffic data to support transportation planning and engineering. However, that patent did not address the current need to combine demographic and socioeconomic data with traffic data for use in urban planning and transportation engineering.

### BRIEF SUMMARY OF THE INVENTION

The present invention addresses the above and other needs by providing techniques for fusing marketing data with cellular or other mobile-device data to generate synthetic travel datasets as a cost effective replacement or supplement for household travel surveys and other traditional methods of data collection in the fields of urban planning and transportation engineering. In some embodiments, the technique comprises obtaining and/or generating marketing data for one or more study areas disaggregated at the individual and/or household levels, obtaining cellular data for the study area(s) aggregated into probabilistic distributions for geographic subareas within the study area(s), and associating travel and activity information from the cellular data with individuals or households in the marketing data by their current residential or commercial subarea using the respective probabilistic distributions in the cellular data.

According to an exemplary embodiment, the present invention is a method. The method includes receiving marketing data for households in a given study area, the marketing data including location data for each of the households, and determining, based on the marketing data, household-level demographic and socioeconomic data for a plurality of households associated with the given study area. The method further includes determining, for each of the plurality of households, and based on the demographic and socioeconomic data, one or more trips the respective household is predicted to make over a given time period, and receiving, cellular data indicating aggregate movements in the given study area for a plurality of mobile devices. The method yet further includes generating, by computing device, a synthetic travel dataset based on simulating the one or more trips for each respective household of the plurality of households, wherein each trip is simulated based on the location data associated with the respective household and a random time and location represented in the cellular data.

In further embodiments, the synthetic travel dataset can be inputted into a travel demand model. The method can be repeated to create a plurality of synthetic travel datasets for use in a time series forecasting model. The marketing data can be empirical marketing data, and the household-level demographic and socioeconomic data for the plurality of households can be determined at least partially by altering or applying population synthesis to the empirical marketing data.

In additional further embodiments, the aggregate movements for the plurality of mobile devices can be at least partially represented by temporal and geographic probability distributions. The aggregate movements can originate and end within the given study area. The trips for the plurality of households can comprise various types of trips, and the cellular data can indicate aggregate movements associated with each of the various types of trips.

In additional further embodiments, the trips for the plurality of individuals can comprise various types of trips, and the cellular data can indicate aggregate movements associated with each of the various types of trips. The trips for the plurality of individuals can comprise trips associated with various purposes, and the cellular data can indicate aggregate movements associated with each of the various types of trip purposes. The trips for the plurality of individuals can comprise trips via various modes of transportation, and the cellular data can indicate aggregate movements associated with each of the various modes of transportation.

According to another exemplary embodiment, the present invention is a system comprising at least one processor; at least one memory operatively coupled to the at least one processor and configured for storing data and instructions that, when executed by the processor, cause the at least one processor to perform a method substantially similar to the first method described above.

According to yet another exemplary embodiment, the present invention is a non-transitory computer-readable storage medium having instructions encoded thereon that, when executed by a computing device, causes the computing device to perform a method substantially similar to the first method described above.

### BRIEF DESCRIPTION OF THE DRAWINGS

FIG. 1 provides a process flow diagram of a method, according to an exemplary embodiment.

FIG. 2 provides a process flow diagram of an environment in which the invention operates, according to an exemplary embodiment.

FIG. 3 provides a process flow diagram of another environment in which the invention operates, according to an exemplary embodiment.

FIG. 4 provides a block diagram of computing device, according to an exemplary embodiment.

### DETAILED DESCRIPTION OF THE INVENTION

The present invention provides techniques for creating a synthetic travel dataset for urban planning and transportation engineering by fusing demographic and socioeconomic information from marketing data with travel and activity information from cellular data.

To facilitate an understanding of the principles and features of the various embodiments of the invention, various illustrative embodiments are explained below. Although exemplary embodiments of the invention are explained in detail, it is to be understood that other embodiments are contemplated. Accordingly, the invention is not limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component can include composition of a plurality of components. References to a composition containing “a” constituent can to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As utilized herein, the term “marketing data” refers to classification data collected at the individual or household levels including, for example, demographic and socioeconomic data. “Demographic data” refers to essential information about a population such as age, sex, and race. “Socioeconomic data” refers to information that characterizes an individual's or family's economic or social position in relation to others such as income, education, and occupation.

As utilized herein, the terms “cellular data” or “mobile-device data” refers to data that can be used to determine the location or movement of an asset, for example, a base station or mobile device, the mobile device indicative of the movement of an asset in proximity to the mobile device.

Various systems, methods, and computer-readable mediums may be utilized for generating a synthetic travel dataset and will now be described with reference to the accompanying figures.

In an exemplary embodiment, the present invention 100 is a method for generating a synthetic travel dataset 110. The method comprises obtaining classification data 120 of instances 130 of at least one asset class 140 in at least one study area 150, obtaining travel data 160 of at least one instance 130 of at least one asset class 140, and associating at least a portion of the classification data 120 with the travel data 160 via an association methodology 170.

At its core, the present invention seeks to associate classification data 120 of a member 130 of an asset class 140 with travel data 160 of that member 130. In an exemplary embodiment, the asset class 140 can be a household 142, a member 130 of the household 142 can be an individual 132, the classification data 120 can be marketing data 122, and the travel data 160 of that individual 132 in the household 142 can include wireless tracing of trips the individual 132 makes within the study area(s) 150.

The asset class 140 can include one or more of households 142, individuals and modes of transportation. Instances 130 of an asset class depend on the asset class. For example, instances 130 of a household 142 can be a household with a single individual 132 living at the household, or cumulatively represent the individuals living/owning/renting the household. In such a manner, the present invention seeks to associate data about the individuals with data about the way the individuals travel.

If the asset class were defined as modes of transportation, then an instance of that asset class might be cars, motorcycles or other transportation vehicles. In such a manner, the present invention seeks to associate data about the location where the vehicle mainly stations, with data about the way the vehicle travels. Thus, for example, the wireless tracing may not be via a mobile phone associated with the movements of an individual carrying the phone, but would track a vehicle that had a GPS or other tracing system associated with it, and thus a particular driver (particular phone) would not be of such importance, the tracing of the vehicle would be of most importance.

In an exemplary embodiment, the study area(s) 150 can include census blocks, census block groups, transportation analysis zones (TAZs), grid cells, or other similar method of delineating geographic space. Classification data 120 can include demographic and socioeconomic data of the assets 130. The travel data 160 can include asset 130 commute trips, work-generated trips, trips generated for dependents, shopping trips, school trips, and social trips.

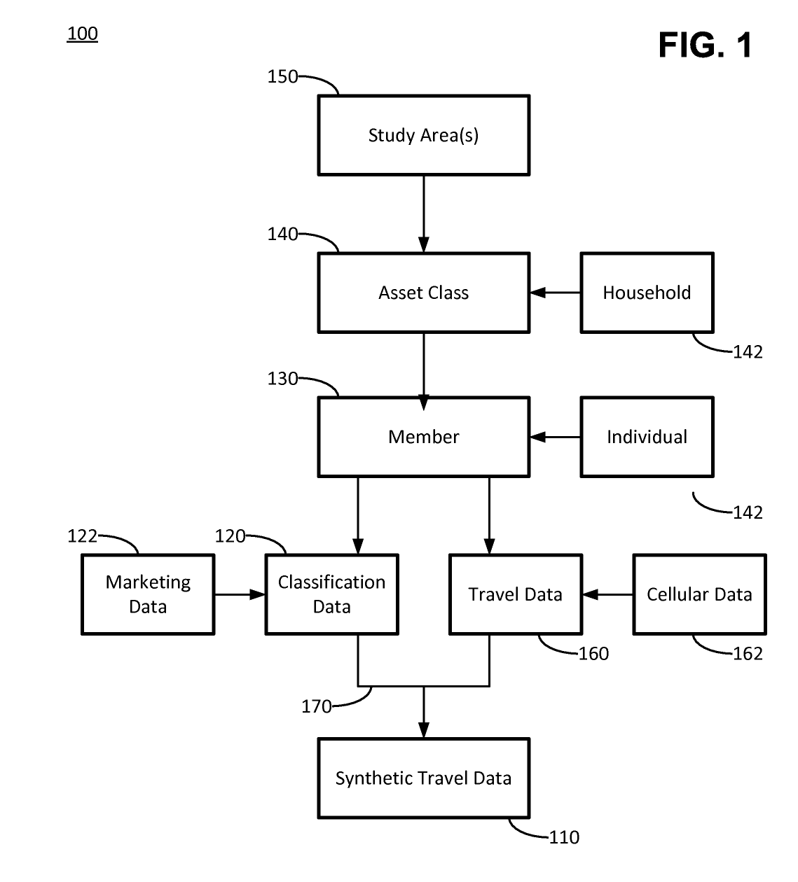

FIG. 1 provides a process flow diagram of a method 100, according to an exemplary embodiment. Referring to FIG. 1, marketing data 122 are obtained as disaggregate individual-or household-level demographics and socioeconomics of those living in the given study area(s) 150. The individual or household's current address, geographic coordinates, or the small geographic subarea with which the method 100 is operating can be present in the data. Non-limiting examples of small geographic subareas include, for example, a census block, census block group, transportation analysis zone (TAZ), and grid cell.

In an exemplary embodiment, travel data 160 can comprise cellular or other mobile data 162 obtained as probability distributions for each small geographic subarea within the given study area(s) 150 both temporally and geographically. In some implementations, cellular data may be received from third-parties. Traditionally, individual- or household-level travel or activity behaviors cannot be released by third-party cellular data providers due to privacy concerns. Thus in some embodiments, aggregate cellular data may be received, e.g., probability distributions for a plurality of devices. In another implementation, cellular data may be actively collected as part of the present invention.

In some exemplary embodiments, the cellular data 162 probability distributions are obtained separately for each type of trip or activity in the study originating and ending in each small geographic subarea by travel mode. Non-limiting examples of trip or activity types include, for example, commute trips, work-generated trips, trips generated for dependants, shopping trips, school trips, and social trips. Non-limiting examples of probabilistic distributions include, for example, the binomial or multinomial distribution, Poisson distribution, normal or multivariate normal distribution, chi-squared distribution, logarithmic distribution, and others.

The synthetic travel data 110 can be generated by the association methodology 170 using the following non-limiting example. For each individual or household in each subarea that would likely make a particular type of trip or activity as determined or predicted from the disaggregate demographic and socioeconomic data, a time and location for a synthetic trip or activity are randomly and independently drawn from the probability distributions and assigned to that individual or household. The process is repeated over every individual or household, small geographic subarea, travel mode, and trip or activity within the study. In this way, a synthetic travel dataset can be formulated with individual- or household-level demographic and socioeconomic characteristics.

Optionally, this method could be repeated using a Monte Carlo method or the like, for example, where the random and independent draws are repeated at least once. The resulting synthetic travel data 110 could optionally take the form of traditional household travel survey data, wherein each individual or household has a complete associated trip or activity schedule.

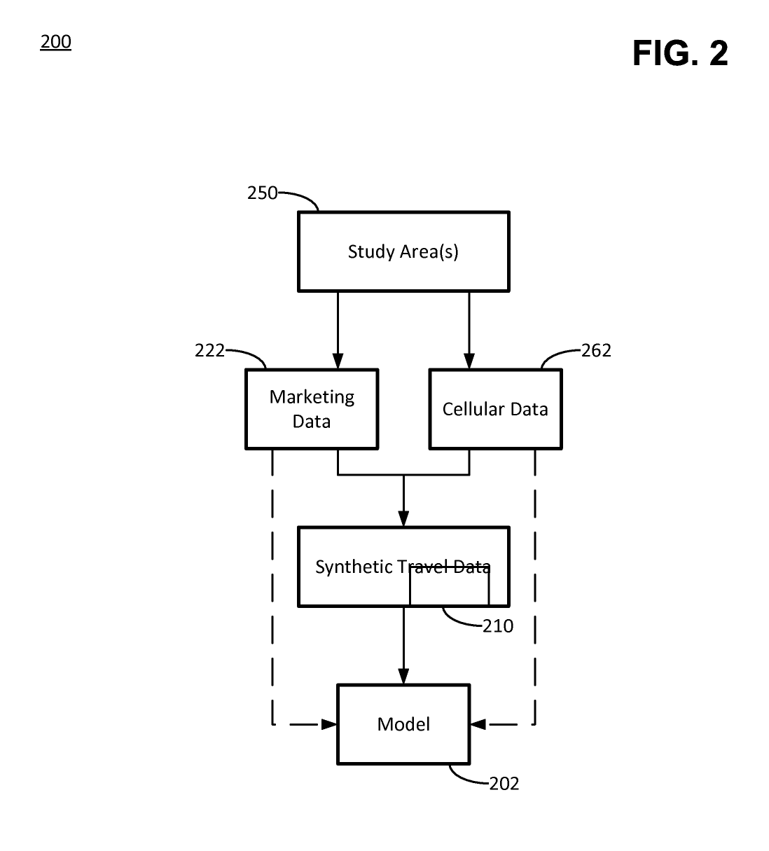

FIG. 2 provides a process flow diagram of an operating environment 200 in which the invention operates, according to an exemplary embodiment. In an exemplary embodiment, the operating environment 200 could be an urban planning and transportation engineering environment where the model 202 is a traditional four-step or activity-based model, or other model not yet conceived. Another operating environment 200 could be a real estate or business environment where the model 202 is a residential or business location model, or other model not yet conceived.

In either of these non-limiting operating environments 200, the synthetic travel data 210 operates as input data into the model 202. The originating marketing data 222 and cellular data 262 could also optionally be inputs into the model 202, as well as any other non-specified inputs.

The method 100 for generating the synthetic travel data 210 can be repeated at least once over any amount of time for the same or similar study area(s) 250. The updated synthetic travel data 210 can either automatically or manually update the model 202 at regular or irregular intervals. Non-limiting examples of the frequency at which this could occur include, for example, every month, quarter, year, or decade.

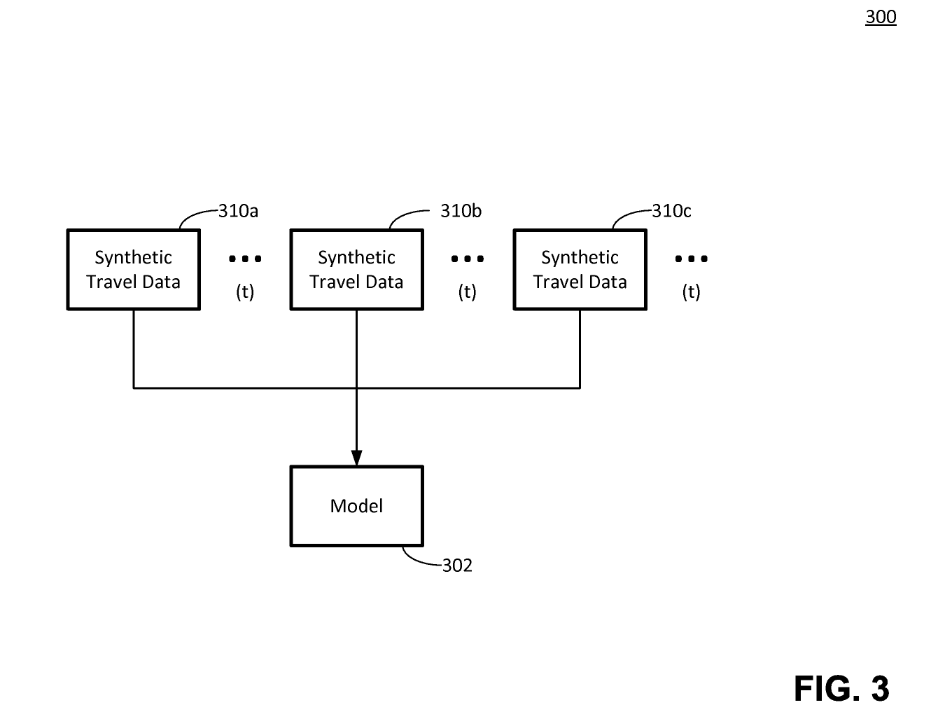

FIG. 3 provides a process flow diagram of another environment in which the invention operates, according to an exemplary embodiment. The synthetic travel data 310a-c are generated at least once over regular or irregular time intervals and stored. Non-limiting examples of the frequency at which this could occur include, for example, every month, quarter, year, or decade. Each synthetic travel data instance 310 can be used as time series data inputs into the model 302. Future forecasts could then be made with new processes or models 302 that might be conceived. Such forecasting processes or models 302 might include, for example, a moving-average (MA) model, weighted moving-average model, autoregressive moving-average (ARMA) model, exponential smoothing, Kalman filtering, extrapolation, linear prediction, trend estimation, data mining, machine learning, pattern recognition, simulation, probabilistic forecasting, or other time series models.

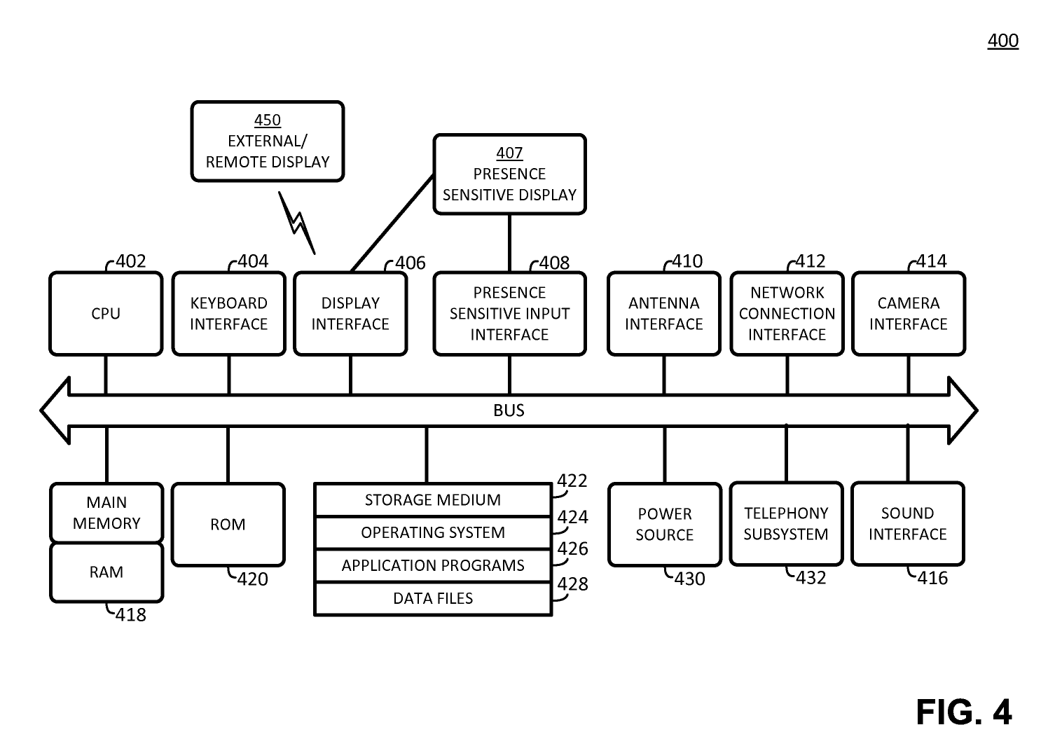

FIG. 4 provides a block diagram of computing device, according to an exemplary embodiment. Certain aspects of the present invention may be embodied in a computing device (for example, a dedicated server computer or a mobile computing device). As desired, embodiments of the present invention may include a computing device with more or less of the components illustrated in FIG. 4. It will be understood that the computing device architecture 400 is provided for example purposes only and does not limit the scope of the various embodiments of the present disclosed systems, methods, and computer-readable mediums.

The computing device architecture 400 of FIG. 4 includes a CPU 402, where computer instructions are processed; a display interface 406 that acts as a communication interface and provides functions for rendering video, graphics, images, and texts on the display. According to certain some embodiments of the present invention, the display interface 406 may be directly connected to a local display, such as a touch-screen display associated with a mobile computing device. In another example embodiment, the display interface 406 may be configured for providing data, images, and other information for an external/remote display that is not necessarily physically connected to the mobile computing device. For example, a desktop monitor may be utilized for mirroring graphics and other information that is presented on a mobile computing device. According to certain some embodiments, the display interface 406 may wirelessly communicate, for example, via a Wi-Fi channel or other available network connection interface 412 to the external/remote display.

In an example embodiment, the network connection interface 412 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 400 may include a keyboard interface 404 that provides a communication interface to a keyboard. In one example embodiment, the computing device architecture 400 may include a presence-sensitive display interface 407 for connecting to a presence-sensitive display. According to certain some embodiments of the present invention, the presence-sensitive display interface 407 may provide a communication interface to various devices such as a pointing device, a touch screen, a depth camera, etc. which may or may not be associated with a display.

The computing device architecture 400 may be configured to use an input device via one or more of input/output interfaces (for example, the keyboard interface 404, the display interface 406, the presence sensitive display interface 407, network connection interface 412, camera interface 414, sound interface 416, etc.) to allow a user to capture information into the computing device architecture 400. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 400 or may be a separate device. For example, the input device may be an accelerometer, a magnetometer, a digital camera, a microphone, and an optical sensor.

Example embodiments of the computing device architecture 400 may include an antenna interface 410 that provides a communication interface to an antenna; a network connection interface 412 that provides a communication interface to a network. According to certain embodiments, a camera interface 414 is provided that acts as a communication interface and provides functions for capturing digital images from a camera. According to certain embodiments, a sound interface 416 is provided as a communication interface for converting sound into electrical signals using a microphone and for converting electrical signals into sound using a speaker. According to example embodiments, a random access memory (RAM) 418 is provided, where computer instructions and data may be stored in a volatile memory device for processing by the CPU 402.

According to an example embodiment, the computing device architecture 400 includes a read-only memory (ROM) 420 where invariant low-level system code or data for basic system functions such as basic input and output (I/O), startup, or reception of keystrokes from a keyboard are stored in a non-volatile memory device. According to an example embodiment, the computing device architecture 400 includes a storage medium 422 or other suitable type of memory (e.g., RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 424, application programs 426 (including, for example, a web browser application, a widget or gadget engine, and or other applications, as necessary) and data files 428 are stored. According to an example embodiment, the computing device architecture 400 includes a power source 430 that provides an appropriate alternating current (AC) or direct current (DC) to power components. According to an example embodiment, the computing device architecture 400 includes a telephony subsystem 432 that allows the device 400 to transmit and receive sound over a telephone network. The constituent devices and the CPU 402 communicate with each other over a bus 434.

According to an example embodiment, the CPU 402 has appropriate structure to be a computer processor. In one arrangement, the CPU 402 may include more than one processing unit. The RAM 418 interfaces with the computer bus 434 to provide quick RAM storage to the CPU 402 during the execution of software programs such as the operating system application programs, and device drivers. More specifically, the CPU 402 loads computer-executable process steps from the storage medium 422 or other media into a field of the RAM 418 in order to execute software programs. Data may be stored in the RAM 418, where the data may be accessed by the computer CPU 402 during execution. In one example configuration, the device architecture 400 includes at least 125 MB of RAM, and 256 MB of flash memory.

The storage medium 422 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 422, which may comprise a machine-readable storage medium.

According to one example embodiment, the term computing device, as used herein, may be a CPU, or conceptualized as a CPU (for example, the CPU 402 of FIG. 4). In this example embodiment, the computing device may be coupled, connected, and/or in communication with one or more peripheral devices, such as display.

Certain embodiments of the present invention are described above with reference to block and flow diagrams of systems, methods, or computer program products according to example embodiments of the present invention. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

While several variations of the present invention have been illustrated by way of example in preferred or particular embodiments, it is apparent that further embodiments could be developed within the spirit and scope of the present invention, or the inventive concept thereof However, it is to be expressly understood that such modifications and adaptations are within the spirit and scope of the present invention, and are inclusive, but not limited to the following appended claims as set forth.

What is claimed is:

1. A method comprising:
receiving marketing data for a first plurality of households associated with a given study area, the marketing data including location data for the first plurality of households;
determining, based on the marketing data, household-level demographic and socioeconomic data for a second plurality of households associated with the given study area;
determining, for the second plurality of households, and based on the demographic and socioeconomic data, trips respective households are predicted to make over a given time period;
receiving, mobile-device data indicating aggregate movements in the given study area for a plurality of mobile devices; and
generating, by a computing device, a synthetic travel dataset based on simulating the trips for the respective households of the second plurality of households, wherein the trips are simulated based on random times and locations represented in the mobile-device data.

2. The method of claim 1, further comprising using the synthetic travel dataset with a travel demand model.

3. The method of claim 1, further comprising:
repeating the generating of a synthetic travel dataset to create a plurality of synthetic travel datasets useable in a time series forecasting model.

4. The method of claim 1, wherein the marketing data is empirical marketing data and the household-level demographic and socioeconomic data for the second plurality of households are determined at least partially by applying population synthesis to the empirical marketing data for the first plurality of households.

5. The method of claim 1, wherein the aggregate movements for the plurality of mobile devices are at least partially represented by temporal and geographic probability distributions.

6. The method of claim 1, wherein the aggregate movements originate and end within the given study area.

7. The method of claim 1, wherein the trips for the second plurality of households comprise various types of trips, and wherein the mobile-device data indicates aggregate movements associated with each of the various types of trips.

8. A system comprising:
at least one processor;
at least one memory operatively coupled to the at least one processor and configured for storing data and instructions that, when executed by the processor, cause the at least one processor to perform a method comprising:
receiving empirical marketing data for a first plurality of individuals associated with a given study area, the marketing data including location data for the first plurality of individuals;
determining, based on the marketing data, individual-level demographic and socioeconomic data for a second plurality of individuals associated with the given study area;
determining, for each of the second plurality of individuals, and based on the demographic and socioeconomic data, trips the respective individual is predicted to make over a given time period;
receiving, mobile-device data indicating aggregate movements in the given study area for a plurality of mobile devices; and
generating, by a computing device, a synthetic travel dataset based on simulating the trips for the respective individuals of the second plurality of individuals, wherein the trips are simulated based on random times and locations represented in the mobile-device data.

9. The method of claim 8, further comprising inputting the synthetic travel dataset into a travel demand model.

10. The method of claim 8, wherein the aggregate movements for the second plurality of mobile devices are at least partially represented by temporal and geographic probability distributions.

11. The method of claim 8, wherein the aggregate movements include movement origins and destinations.

12. The method of claim 8, wherein the aggregate movements originate and end within the given study area.

13. The method of claim 8, wherein the trips for the second plurality of individuals comprise various types of trips, and wherein the mobile-device data indicates aggregate movements associated with each of the various types of trips.

14. The method of claim 8, wherein the trips for the second plurality of individuals comprise trips associated with various purposes, and wherein the mobile-device data indicates aggregate movements associated with each of the various types of trip purposes.

15. The method of claim 8, wherein the trips for the second plurality of individuals comprise trips via various modes of transportation, and wherein the mobile-device data indicates aggregate movements associated with each of the various modes of transportation.

16. The method of claim 8, wherein the marketing data is empirical marketing data and the asset-level demographic and socioeconomic data are determined at least partially by perturbing the empirical marketing data for the first plurality of households.

17. A non-transitory computer-readable storage medium having instructions encoded thereon that, when executed by a computing device, causes the computing device to perform a method comprising:
receiving marketing data associated with a first plurality of assets associated with a given study area, the marketing data including location data for the first plurality of assets;
determining, based on the marketing data for the given study area, asset-level demographic and socioeconomic data for a second plurality of assets associated with the given study area;
determining, for the second plurality of assets, and based on the demographic and socioeconomic data, trips respective assets are predicted to make over a given time period;
receiving, mobile-device data indicating aggregate movements in the given study area for a plurality of mobile devices; and
generating, by a computing device, a synthetic travel dataset based on simulating the trips for the respective assets of the second plurality of assets, wherein the trips are simulated based on random times and locations represented in the mobile-device data.

18. The method of claim 17, further comprising inputting the synthetic travel dataset into a travel demand model.

19. The method of claim 17, wherein the aggregate movements for the plurality of mobile devices are at least partially represented by temporal and geographic probability distributions.

20. The method of claim 17, wherein the assets are one or more of individuals, households, and transportation implements.
